(19) United States
(12) Patent Application Publication
(10) Pub. No.: US 2007/0028192 A1
(43) Pub. Date: Feb. 1, 2007

(54) Method for providing serialized technical support

(76) Inventor: Frank John Williams, Los Alamitos, CA (US)

Correspondence Address: Frank John Williams, 2711 Saint Albans Dr., Los Alamitos, CA, 90720, US

(21) Appl. No.: 11/497,141

(22) Filed: Aug. 1, 2006

Related U.S. Application Data
(60) Provisional application No. 60/704,815, filed on Aug. 1, 2005.
(60) Provisional application No. 60/764,931, filed on Feb. 3, 2006.

(51) Int. Cl. G05B 11/01

(52) U.S. Cl. 715/859; 70/175; 700/27; 700/108

(57) ABSTRACT

A method and system for obtaining service information procedures implementing serialized status identifiers. Wherein, the provided information involves the implementation of at least one motion picture demonstrating at least one service procedure of an apparatus.

### RELATED APPLICATIONS

This is application claims the benefit of: provisional patent application Ser. No. 60/704,815, filed 2005 Aug. 1, and provisional patent application Ser. No. 60/764,931 filed 2006 Feb. 3, by the present inventor.

### BACKGROUND

1. Field of the Invention

The present invention relates generally to the delivery of technical information. More particularly, a novel method for providing technical support implementing rich media.

2. Description of Related Art

The most recent technological discoveries along with the revolution of the latest digital communications, have given rise to a variety of new technologies and markets. Necessarily, a new series of respective and essential subsequent markets for both the end-user and the manufacturers have also developed. Faster and more capable machines implicate more complex systems and technologically advanced machines. Unfortunately, all these new technologies come but with a large ticket price to many manufacturers. Delicate and sophisticated machinery requires expert and responsible servicing and repairing. Consequentially, manufactures spend large amounts of money and resources in training and developing the necessary personnel and infrastructures to support this army of new products and machines. As a result, authorized personal is the outcome of such an enterprise. Extremely important to manufactures and their products, authorized personnel take the responsibility of servicing and supplying a series of elements and business opportunities to the manufacturers and their clients alike. Meanwhile, the rapid development of high speed Internet and other means of communication now permit the delivery of all types of files containing a variety of rich media and information. In particular, movies can now be effortlessly distributed with hardly any type of regulation(s). As a consequence, movies demonstrating particular and delicate service procedures can find their ways into any place of the world, dangerously affecting and threatening the manufacturers, the dealerships and ultimately, the authorized service personnel. Since movies can be produced with little or no budget, they can be easily created, distribute and manipulated by non-authorized and/or other types of personnel, which may have insufficient and/or little technical capabilities. In addition, the responsibilities and obligations of such individuals towards the equipment and the industries it represents are doubtful.

A site already implementing one of these informative methods is that of the web site with the address of www.evergreenlaser.com. The site utilizes a rather small number of movies demonstrating the few service procedures of a particular line of commercial lasers. However, other products such as large copying machines require specialized and properly trained personnel to accurately service the machine. For such a type of manufacturer, it can be controversial to find their proprietary data easily disseminated over regions in which or from which they have no legal boundaries and/or protection. Although copyright can potentially offer some level of protection, it is also true that such movie content can be reproduced in different manner to still contain the important methods and procedures without risks of infringement.

In view of the present foregoing and possible market threats, the present invention distinguishes over the prior art by providing heretofore a more compelling system and method to provide technical support to field personnel, end-user, and non-authorized entities while protecting the manufacturers. In addition of unsolved problems, more unknown advantages and objectives are described in the following summary

### SUMMARY OF THE INVENTION

The present invention teaches certain benefits in use and construction which give rise to the objectives and advantages described below. The method and system embodied by the present invention overcomes the limitations and shortcomings encountered by the distribution of technical support information via the World Wide Web and/or other means for communicating by implementing topic and retrieval specialization or serialization.

### OBJECTS AND ADVANTAGES

A primary objective inherent in the above described method of use is to provide a novel method and further unobvious advantages and objectives not taught by the prior art. Accordingly, several objects and advantages of the invention are
a) Another objective is to allow the integration of non-authorized personnel by providing an information distribution and platform that is equally accessible to anybody, such as a movie.
b) Another objective is to protect the financial interests of manufacturers;
c) A further objective is to protect the financial interests of dealerships;
d) A further objective is to protect delicate equipment from incorrect and/or irresponsible servicing procedures;
e) A further objective is to allow for the prompt and proper dissemination of information by inviting more manufacturer involvement;
f) A further objective is to avoid the dissemination of incomplete and/or incompetent information;
g) A further objective is to reduce or remove the paper printing of service manuals;
h) A further objective is to facilitate the sales of original equipment manufacture parts and services;

Other features and advantages of the described methods of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present system and method of use. In such drawings:

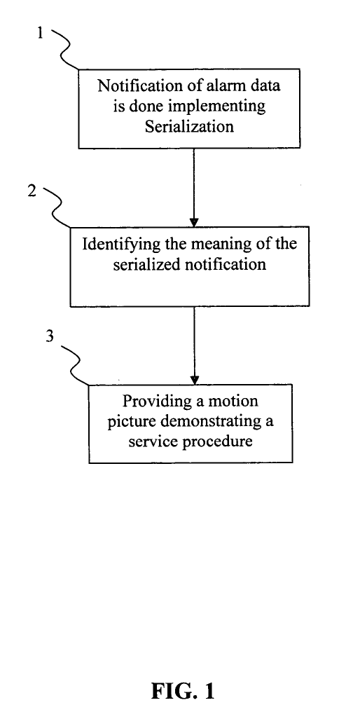

1) FIG. 1 is a perspective view of the inventive method;

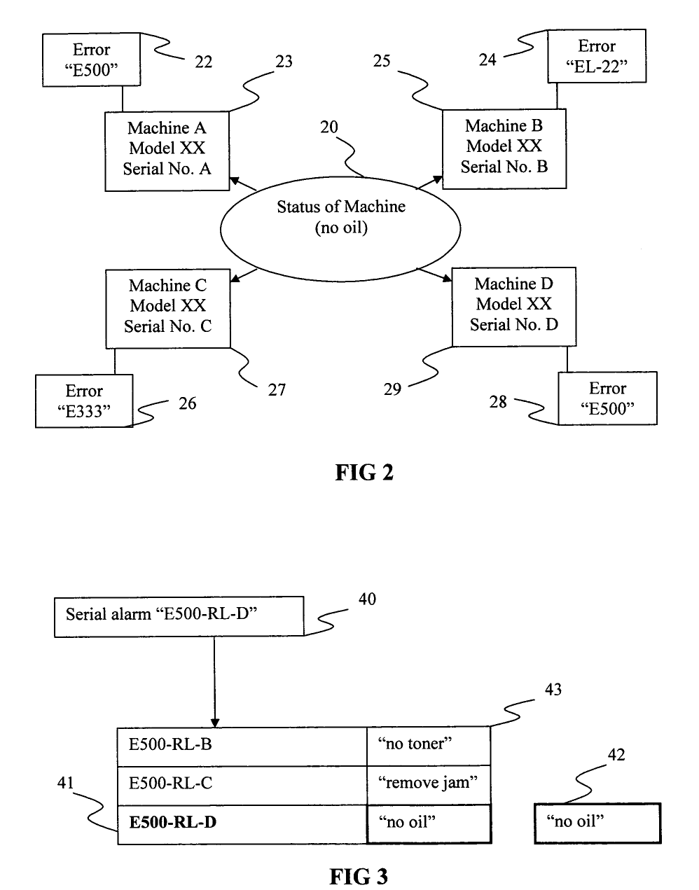

2) FIG. 2 is a perspective view of an “alphanumeric point” or group identifier;

3) FIGS. 3A through 3F illustrate some of the many types, associations and type of data described by a sampling alphanumeric points;

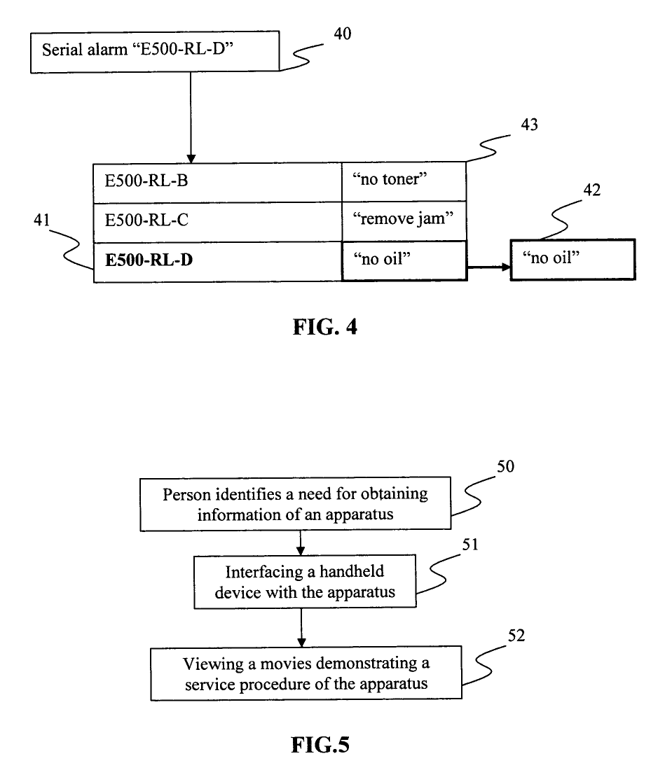

4) FIG. 4 is a view of a converting action;

5) FIG. 5 is a perspective view of a cluster of alphanumeric point databases;

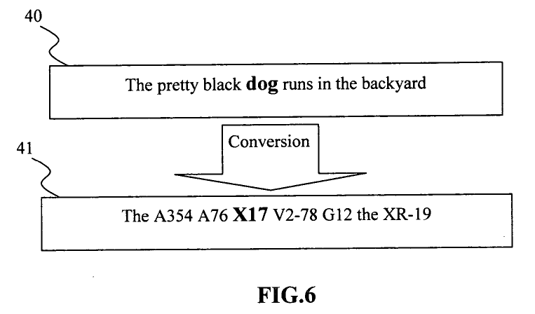

6) FIG. 6 is a perspective view of the areas of information attained implementing the different textual combinations.

### DETAILED DESCRIPTION

[1] The above described drawing figures illustrate the described methods and use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present system and method of use.

[2] FIG. 1 shows a perspective view of a basic inventive method. This disclosure describes a method for providing technical support implementing movies demonstrating particular servicing procedures as to inform and/or teach users, technicians, authorized technicians and third party personnel, while protecting the servicing information and respective interests and investments of the manufacturers and/or others entities objectively involved. The particular order of the steps described in the present inventive method is of no relevance since many of these steps can occur simultaneously and/or be previously archived. The method includes the initial step 1 (FIG. 1) of “serializing” any message(s) the equipment displays in response to a change in status and/or functionality. In further detail, a large digital color copier, for example, is capable of displaying a variety of errors codes when a particular function and/or part fails to operate within the permissible levels. Such an error code identifies the problem instructing service personnel as to what is wrong with the equipment. In addition, the errors codes (also referred as “message and malfunction displaying identifiers”) are indeed all identical in their identifying nature. In other words, within a particular model “XX” for example, an error code such as “E-500” meaning that there is no oil in the fuser is equally displayed by all the XX model machines when indeed they have no oil. In consequence, “serialization” means that each machine has its own message for each of its malfunctions per se. For example, when a machine A of model XX runs out of oil, the error code is “E500”; but when a machine B of the same model XX runs out of oil, the error code is “EL-22”. Although the codes displayed are different, the meaning or information pertained is identical (no oil). Therefore, provided that the machine is identified (and/or other entity in association to the particular machine) when an error code occurs per se, it is then possible to find the general meaning for every code for every single machine. Many other messages and controlling features are now part of complex machines such as the color copier above. From “service mode” (technician's access to programming, troubleshooting and displaying functional information within the apparatus) to user messages to even communications in between machines, the data can be objectively “serialized,” thus making it extremely difficult for personnel to “communicate” with the machine (or vice versa) when the proper decoding and/or associated information is not at hand. FIG. 2 is an exemplary illustration of how the meaning or message 20 (FIG. 2) “no oil” per se, is being displayed as “E500” in 22 (FIG. 2), “EL-22” in 24 (FIG. 2), “E333” in 26 (FIG. 2) and “E500” in 28 (FIG. 2) by the identical model machines 23 (FIG. 2), 25 (FIG. 2), 27 (FIG. 2) and 29 (FIG. 2) respectively. Noteworthy, machine A 23 (FIG. 2) and machine D 29 (FIG. 2) both still use the same nomenclature of “E500” (22 (FIG. 2) and 28 (FIG. 2) respectively) for the “no oil” alarm. Although a set of machines can still share the same machine status identifiers, other sets may not. As a consequence, it can be rather difficult to know to which set a particular machine belongs to. In addition, other status nomenclatures may vary within each set.

[3] The next step 2 (FIG. 1) of the inventive method is to identify the meaning or concept behind the serialized message or alarm from step 1 (FIG. 1). There are many different ways to associate particular information with other data. One example is that accomplished by a database. FIG. 3 intents to illustrate how a serialized message 30 (FIG. 3) and a “machine status identifier” 31 (FIG. 3) is searched in a database 32 (FIG. 3) to find its meaning 33 (FIG. 3). By machine identifier, it is meant any information capable of identifying the machine directly or indirectly. For example, a direct identifier is a serial number; while an indirect identifier is the client ID or identification which ultimately is associated to the particular machine(s). Another sample is illustrated by FIG. 4; the message identifying the machine issue 40 (FIG. 4) is so unique that only one record 41 (FIG. 4) with the meaning 42 (FIG. 4) exists in the database 43 (FIG. 4). Another sample is that of encrypting the generic message of the issue with information identifying the machine per se. In such fashion, the encrypted message can be reconverted using the machine identifier or other. In reality, the number of combinations may be infinite, but the intention of obscuring the message(s) is still the same and that is part of the spirit of the disclosed inventive method.

[4] Finally, the last step 3 (FIG. 1) is to provide the servicing information in the preferred form of a movie and/or other type of graphic motion display. The number or variety of methods and machines existing and fore coming to “provide” the movies (or other) is just as large as the possible number and different ways of encrypting the machine's message itself.

[5] FIG. 5 shows a non-limiting sample of a diagram in which a technician 50 (FIG. 5) per se, interfaces a handheld device with the machine to obtain the movie(s) not only describing the problem, but better yet, demonstrating the technician how to repair the machine. FIG. 6 illustrates a method wherein an end-user does the obvious first step of identifying a need to obtain service or help information due to a displayed “status identifier” 60 (FIG. 6), then he/she enters an Internet site, then the serialized status identifier (or message) is entered in a search field of the Internet site, then the search feature of the Internet site finds a motion picture demonstrating the particular service procedure(s) associated to the status identifier, and finally the client views the demonstration for fixing or addressing the particular issue.

[6] In addition, further authorizing methods and systems can be used to aid the technical population, clientele and manufacturers. For example, a technician with a handheld service video device contains the statues identifiers for machines A and B. If machine C is to be serviced, no data associating the status identifier of C can be found, therefore no movies (or others) can be displayed per se. A more meaningful sample is the following: a non-authorized technician is indeed capable of repairing a machine provided he/she knows all the necessary steps and procedures to repair the given issue. A movie in fact can effectively deliver such important information in way that allows the unfamiliar technician to perform a good and complete job. Such technician can pay a small fee to the technical support department or pay for a website subscription to obtain the vital service information (currently, manufacturers and support departments have no means to profit or recover expenses from such non-authorized personnel). In this way, the manufacturer, the non-authorized technician and ultimately the client can all benefit from such an event. Better yet, parts and supplies are quickly identified allowing for their rapid and effortlessly acquisition, reducing machine downtime and other complications occurring from ordering parts using conventional methods.

[7] The enablements described in detail above are considered novel over the prior art of record and are considered critical to the operation of at least one aspect of the method and/or apparatuses implementing the method. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

[8] The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

[9] Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

[10] The scope of this description is to be interpreted only in conjunction with the appended claims and it is made clear, here, that each named inventor believes that the claimed subject matter is what is intended to be patented.

### CONCLUSION

From the foregoing, a novel method for providing technical support information can be appreciated. The described method overcomes the reprobation(s) of uncontrolled dissemination of technical information in particular that of technical videos. Furthermore, the method and system(s) promotes the incorporation of non-technical personnel in a manner beneficial to all parties involved.

1. A method for informing the status, including at least one of a: status, message, and information, of an apparatus of a group, the method comprising the steps of:
a) Implementing a first information for identifying the status of a first apparatus of a particular model;
b) Implementing a second information for identifying said status of a second apparatus of said particular model;
Wherein, said particular model apparatuses identify said status implementing at least one of a: said first information, and said second information, respectively.

2. A method for associating status identifiers to the information pertaining generic message.
a) Implementing a word group identifier for identifying a word of a field of search, wherein said word belongs to the group of words being identified by said identifier;
b) Implementing a word group identifier for identifying a word of a query field, wherein said word belong to the group of words being identified by said identifier;
c) Implementing said identifying word group identifiers for performing a finding action, including at least one of a: search, match, retrieval and allocation.

3. The method for providing serialized technical support:
a) Identifying a serial information of an apparatus identifying a status;
b) Implementing a database for identifying a second information identifying said status;
c) Implementing said second information for identifying a motion picture demonstrating a service procedure of said status;
d) Providing an information identifying said motion picture to a client including at least one of a: human, apparatus, and program.
